(19) United States
(12) Patent Application Publication
(10) Pub. No.: US 2013/0020057 A1
(43) Pub. Date: Jan. 24, 2013

(54) COOLING UNIT

(71) Applicants: Masumi SUZUKI, Kawasaki (JP); Michimasa AOKI, Kawasaki (JP); Yosuke TSUNODA, Tachikawa (JP); Kenji KATSUMATA, Odawara (JP); Shinichirou KOUNO, Machida (JP); Masaru SUGIE, Hino (JP)

(72) Inventors: Masumi SUZUKI, Kawasaki (JP); Michimasa AOKI, Kawasaki (JP); Yosuke TSUNODA, Tachikawa (JP); Kenji KATSUMATA, Odawara (JP); Shinichirou KOUNO, Machida (JP); Masaru SUGIE, Hino (JP)

(73) Assignee: FUJITSU LIMITED, Kawasaki-shi, Kanagawa (JP)

(21) Appl. No.: 13/533,027

(22) Filed: Jun. 26, 2012

(30) Foreign Application Priority Data
Jul. 22, 2011 (JP) 2011-161392

(51) Int. Cl. G06F 1/20; F28D 15/00

(52) U.S. Cl. 165/104.31; 165/104.33

(57) ABSTRACT

A cooling unit includes: a flow path that circulates coolant; and a tank that stores the coolant, the tank including a plurality of side walls, an inlet that is provided in a first side wall of the plurality of side walls and through which the coolant is caused to flow in, an outlet that is provided in a second side wall other than the first side wall and located below the inlet and through which the coolant is discharged, and an overhanging portion provided on the inner wall surface of the second side wall and located above the outlet.

### CROSS-REFERENCE TO RELATED APPLICATION

This application is based upon and claims the benefit of priority of the prior Japanese Patent Application No. 2011-161392, filed on Jul. 22, 2011, the entire contents of which are incorporated herein by reference.

### FIELD

The embodiments disclosed herein are related to a cooling unit that cools electronic components mounted in an electronic device, using coolant.

### BACKGROUND

In recent years, in PC servers, the rack-mount system has become mainstream. In the rack-mount system, a plurality of server modules are mounted so that they are stacked on top of each other in a rack cabinet. One or more integrated circuit elements (LSIs) typified by processors (CPUs) are mounted on each server module. In a server or a personal computer, a dedicated fan is placed immediately above a component that generates a large amount of heat, such as a CPU or an LSI, and the component is air-cooled so as to stabilize the operation. However, in the rack mount system, in order to improve performance and to save space, as many server modules as possible have to be stacked in a rack cabinet. For this reason, the thickness of individual server modules has to be reduced. Thus, in rack-mounted server modules, it is difficult to attach a fan directly to a component that generates a large amount of heat, such as a CPU or an LSI. In addition, since the server modules are stacked, it is difficult to release the heat generated in individual server modules to the outside. In order to solve these problems, there is a method to cool a CPU, an LSI, or the like, including circulating coolant over a heat-generating component, such as a CPU or an LSI, circulating the coolant that has absorbed heat from the CPU, LSI, or the like to a radiator with a pump, and cooling the coolant with a cooling fan.

The following is reference documents:
[Document 1] Japanese Laid-open Patent Publication No. 2004-319628
[Document 2] Japanese Laid-open Patent Publication No. 2005-26498

### SUMMARY

According to an aspect of the invention, a cooling unit includes: a flow path that circulates coolant; and a tank that stores the coolant, the tank including a plurality of side walls, an inlet that is provided in a first side wall of the plurality of side walls and through which the coolant is caused to flow in, an outlet that is provided in a second side wall other than the first side wall and located below the inlet and through which the coolant is discharged, and an overhanging portion provided on the inner wall surface of the second side wall and located above the outlet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the structure of a server module employing a cooling unit;

FIG. 2 illustrates the structure of a tank of a first embodiment;

FIG. 3 illustrates the functions of the tanks of the first to third embodiments;

FIG. 4 illustrates the structure of a tank of a fourth embodiment;

FIG. 5 illustrates the structure of a tank of a fifth embodiment;

FIG. 6 illustrates the functions of the tanks of the fifth and sixth embodiments;

FIG. 7 illustrates the functions of the tanks of the seventh and eighth embodiments;

FIG. 8 illustrates the structure and function of a tank of a ninth embodiment; and

FIG. 9 illustrates the structure and function of a tank of a tenth embodiment.

### DESCRIPTION OF EMBODIMENTS

The preferred embodiments of the present disclosure will be described in detail with reference to the drawings.

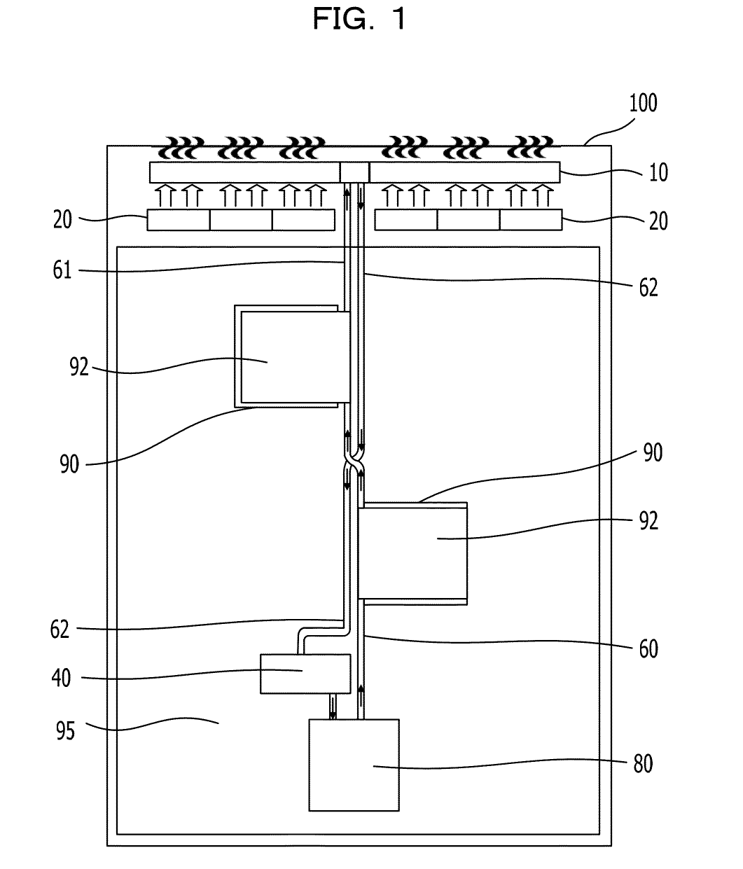

FIG. 1 illustrates the configuration of the inside of a server module employing a cooling unit to which the disclosed technique is applied. A circuit board 95 on which a plurality of CPUs 90 are mounted is disposed inside the server module 100. Cooling jackets 92 for transferring heat from the CPUs to coolant are attached to the CPUs 90. The cooling jackets 92 are made of metal having good thermal conductivity, for example, copper or aluminum.

A radiating fin 10 is disposed at an end of the inside of the server module 100 (in the upper part of FIG. 1). On the inner side of the radiating fin 10, a plurality of fans 20 are disposed. The plurality of fans 20 rotate in a direction such that air is blown toward the radiating fin 10. Air heated by the radiating fin 10 is discharged from the end of the server module 100 to the outside of the server module 100.

The server is usually installed in a temperature controlled room. Thus, the plurality of fans 70 may be rotated in the opposite direction to suck in outside air through the end of the server module 100 to cool the radiating fin 10 with the outside air. Also in this case, a cooling effect is achieved.

A pump 80 is disposed inside the server module 100. Coolant pressurized by the pump 80 is sent out to a pipe 60. After being sent out, coolant absorbs heat from the CPUs 90 in the cooling jacket 92 and is sent to the radiating fin 10 through a pipe 61. Coolant is cooled in the radiating fin 10 by the fans 20 and is returned to the pump 80 by a pipe 62.

In front of the pump 80, a tank 40 is disposed. Coolant is lost through the surface of rubber that makes up the pipes and the surface of resin that makes up the pump 80, and the amount of coolant decreases gradually. The tank 40 stores coolant.

The cooling unit includes the pump 80, the pipe 60, the cooling jackets 92, the pipe 61, the radiating fin 10, the pipe 62, and the tank 40. Coolant circulates through these components, which forms a radiating circulation loop. By arranging this radiating circulation loop linearly and setting the route short, coolant may be returned in a short time and the heat radiating efficiency may be improved. The circuit board 95 is designed centering around the CPUs 90, which are the nerve centers of the circuit, and thus the CPUs 90 are often disposed in the center of the circuit board 95. Thus, the radiating circulation loop is also often disposed across the center of the circuit board 95.

For example, a propylene glycol based antifreeze is used as coolant. However, examples of coolant are not limited to this. Parts of the pipes 60, 61, and 62 are made of a flexible heat-insulating material such as rubber or resin. Parts of the pipes 60, 61, and 62 near the cooling jackets 92 are made of a material having good thermal conductivity such as metal in order to efficiently transfer heat from the CPUs 90 to coolant.

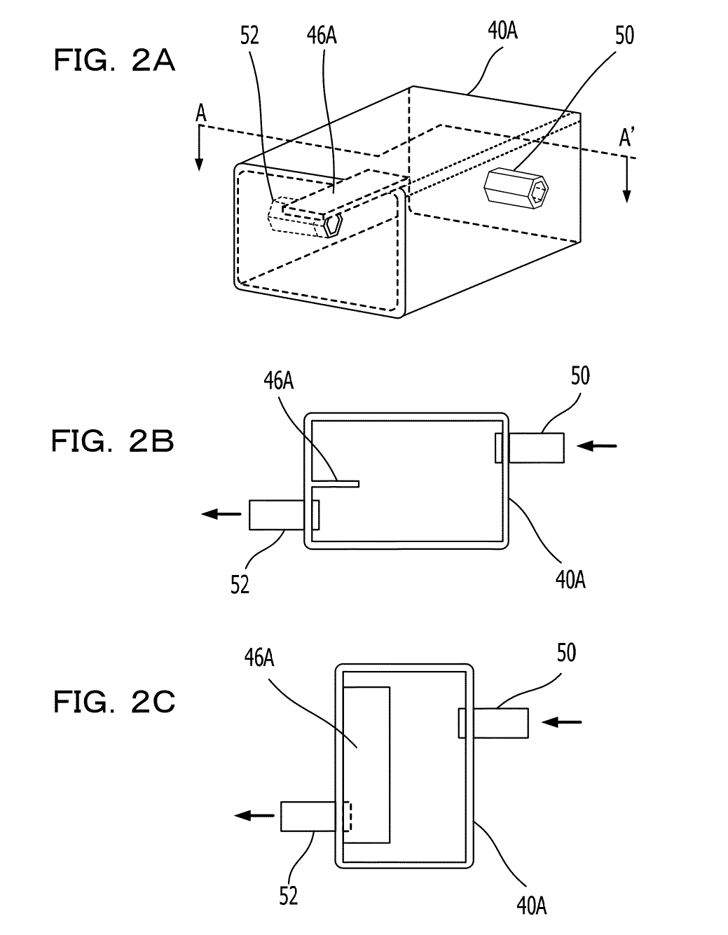

Next, with reference to FIG. 2, a tank 40A of a first embodiment will be described. FIG. 2A is a transparent perspective view of the tank 40A. The pipe 62 is connected to an inlet 50 in one of the side surfaces of the tank 40A. Coolant cooled in the radiating fin 10 is caused to flow through the pipe 62 into the tank 40A. The pump 80 is connected to an outlet 52 in the other side surface of the tank 40A. The pump 80 sucks out coolant from the tank 40A and expels coolant to the pipe 60, thereby producing a flow of coolant. Coolant expelled from the pump 80 is returned to the radiating circulation loop through the pipe 60.

FIG. 2B is a vertical sectional view of the tank 40A in FIG. 2A taken along line IIB-IIB and in the direction of the arrows. FIG. 2C is a horizontal sectional view of the tank 40A in FIG. 2A.

With reference to FIG. 2B, an inlet 50 is provided in the upper part of a side surface of the tank 40A on the right side of FIG. 2B, and an outlet 52 is provided in the lower part of a side surface on the opposite side. Above the outlet 52, a plate-like overhanging portion 46A protruding into the tank 40A is provided. With reference to FIG. 2C, the inlet 50 and the outlet 52 are arranged with a space therebetween so as not to face each other.

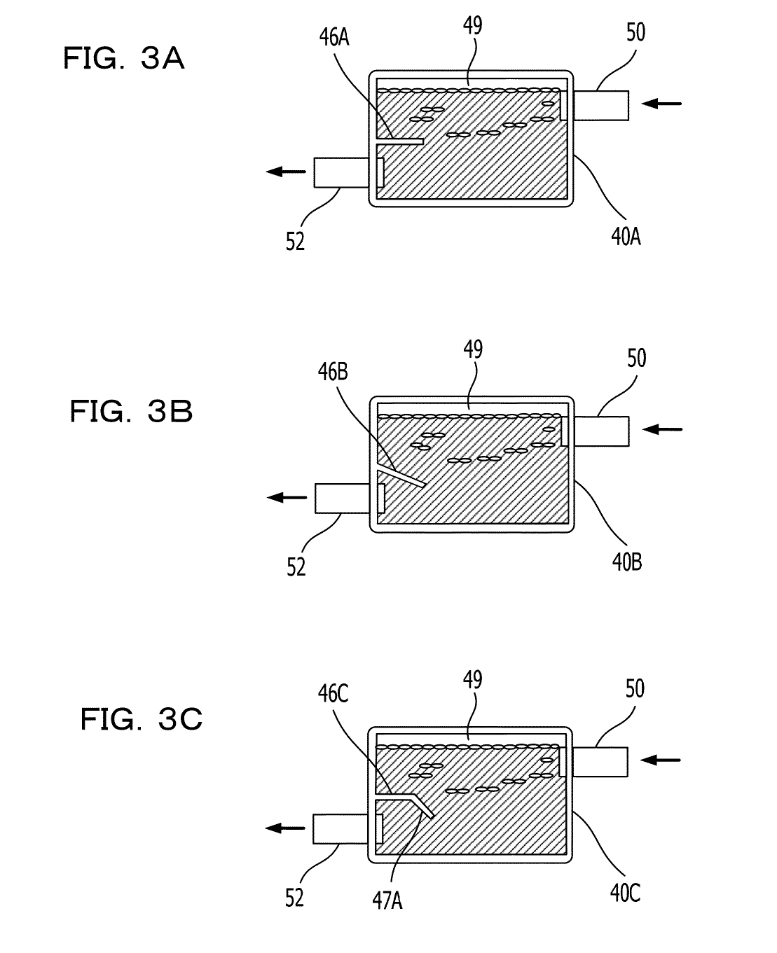

Next, with reference to FIG. 3A, the function of the plate-like overhanging portion 46A will be described.

As described above, in addition to coolant flowing through the radiating circulation loop, coolant for replacing coolant lost through the surface of rubber that makes up the pipes and the surface of resin that makes up the pump is stored in the tank 40A.

At the stage of manufacturing the server module 100, the radiating circulation loop is filled with coolant. The tank 40A is also filled with coolant. Coolant filling is usually performed at room temperature. At this time, air is dissolved in coolant.

When the server module 100 operates and the cooling of the CPUs 90 starts, the temperature of coolant rises, and air dissolved in coolant at room temperature vaporizes to become air bubbles. The air bubbles move through the radiating circulation loop with the flow of coolant. If the air bubbles accumulate in the pump 80, an air lock may arise in the pump 80, and the ability to expel coolant may decrease significantly.

With reference to FIG. 3A, the air bubbles generated in the radiating circulation loop move with the flow of coolant and flow through the inlet 50 into the tank 40A. Since the air bubbles have a lower specific gravity than coolant, the air bubbles accumulate in a region in the upper part of the inside of the tank 40A, and form an air layer 49.

In order not to send the air forming the air layer 49 to the pump 80, the outlet 52 is provided in the lower part of the tank 40A. Even if air bubbles flowing into the tank 40A through the inlet 50 together with coolant sink into coolant, air bubbles near the outlet 52 may be kept from being sucked into the outlet 52, by the plate-like overhanging portion 46A provided above the outlet 52. Thus, according to this embodiment, an air lock of the pump 80 may be suppressed. Since air bubbles generated in the radiating circulation loop finally accumulate in the tank 40A, the amount of coolant flowing through the radiating circulation loop is substantially stable, and a decrease in cooling efficiency may be suppressed.

Next, with reference to FIG. 3B, a tank 40B of a second embodiment will be described. FIG. 3B is a sectional view of the tank 40B. Unlike the overhanging portion 46A of the tank 40A according to the first embodiment, the plate-like overhanging portion 46B of the tank 40B of this embodiment is inclined downward toward the bottom of the tank 40B. Since the plate-like overhanging portion 46B is inclined downward, air bubbles may be kept from being sucked into the outlet 52 even if air bubbles flowing into the tank 40B through the inlet 50 together with coolant sink deeply into coolant.

Next, with reference to FIG. 3C, a tank 40C of a third embodiment will be described. FIG. 3C is a sectional view of the tank 40C. Unlike the overhanging portion 46A of the tank 40A according to the first embodiment, the plate-like overhanging portion 46C of the tank 40C of this embodiment extends from the inner wall of the tank 40C toward the inside in a horizontal direction, but the distal end 47A thereof is inclined downward. Since the distal end 47A of the plate-like overhanging portion 46C is inclined downward, air bubbles may be kept from being sucked into the outlet 52 even if air bubbles flowing into the tank 40C through the inlet 50 together with coolant sink more deeply into coolant.

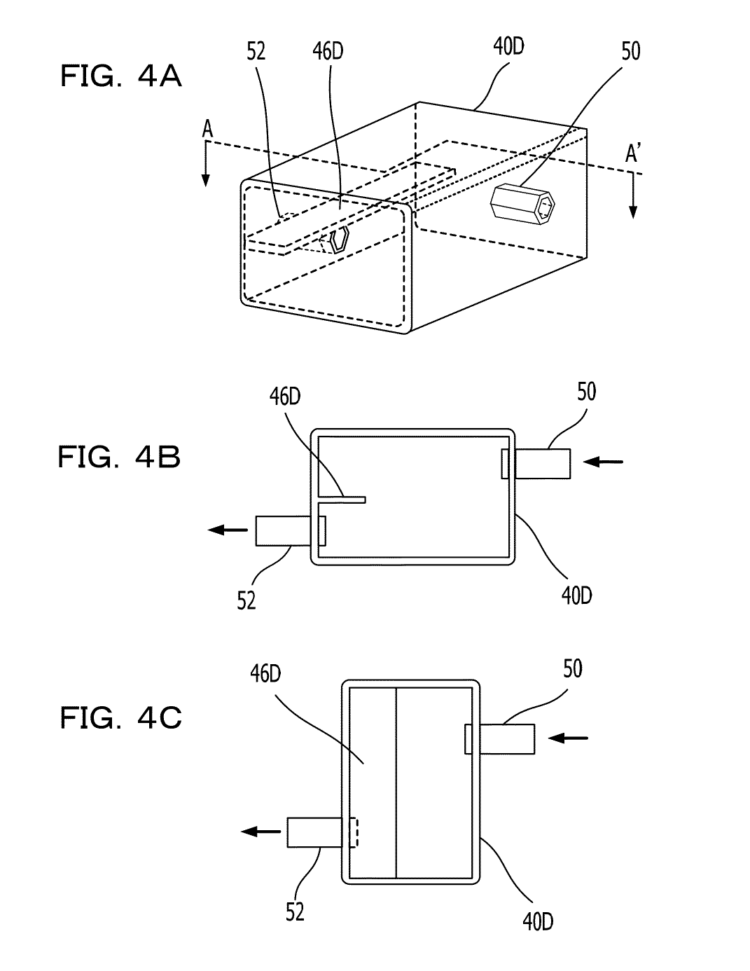

Next, with reference to FIG. 4, a tank 40D of a fourth embodiment will be described. FIG. 4A is a transparent perspective view of the tank 40D. FIG. 4B is a vertical sectional view of the tank 40D in FIG. 4A taken along line IVB-IVB and in the direction of the arrows. FIG. 4C is a horizontal sectional view of the tank 40D in FIG. 4A.

With reference to FIG. 4C, unlike the overhanging portion 46A of the tank 40A according to the first embodiment, the left and right ends of the plate-like overhanging portion 46D of the tank 40D of this embodiment are in contact with the inner wall of the tank 40D. The function of the plate-like overhanging portion 46D of this embodiment is about the same as that of the plate-like overhanging portion 46A of the tank 40A of the first embodiment, which has been described with reference to FIG. 3A.

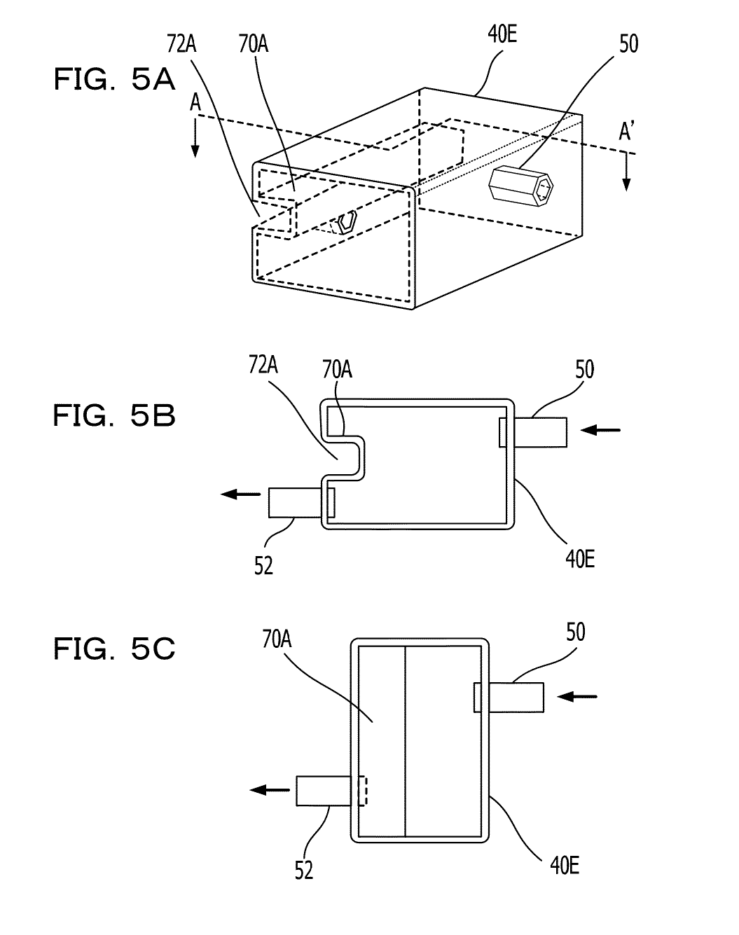

Next, with reference to FIG. 5, a tank 40E of a fifth embodiment will be described. FIG. 5A is a transparent perspective view of the tank 40E. The pipe 62 is connected to an inlet 50 in one of the side surfaces of the tank 40E. Coolant cooled in the radiating fin 10 is caused to flow through the pipe 62 into the tank 40E. The pump 80 is connected to an outlet 52 in the other side surface of the tank 40E. The pump 80 sucks out coolant from the tank 40E and expels coolant to the pipe 60, thereby producing a flow of coolant. Coolant expelled from the pump 80 is returned to the radiating circulation loop through the pipe 60.

FIG. 5B is a vertical sectional view of the tank 40E in FIG. 5A taken along line VB-VB and in the direction of the arrows. FIG. 5C is a horizontal sectional view of the tank 40E in FIG. 5A.

With reference to FIG. 5B, an inlet 50 is provided in the upper part of a side surface of the tank 40E on the right side of FIG. 5B, and an outlet 52 is provided in the lower part of a side surface on the opposite side. Above the outlet 52, a protrusion 70A such that the outer wall of the tank 40E is protruded toward the inside is provided. When viewed from the outside of the tank 40E, a recess 72A is provided in a side surface of the tank 40E along a horizontal direction. With reference to FIG. 5C, the inlet 50 and the outlet 52 are arranged with a space therebetween so as not to face each other.

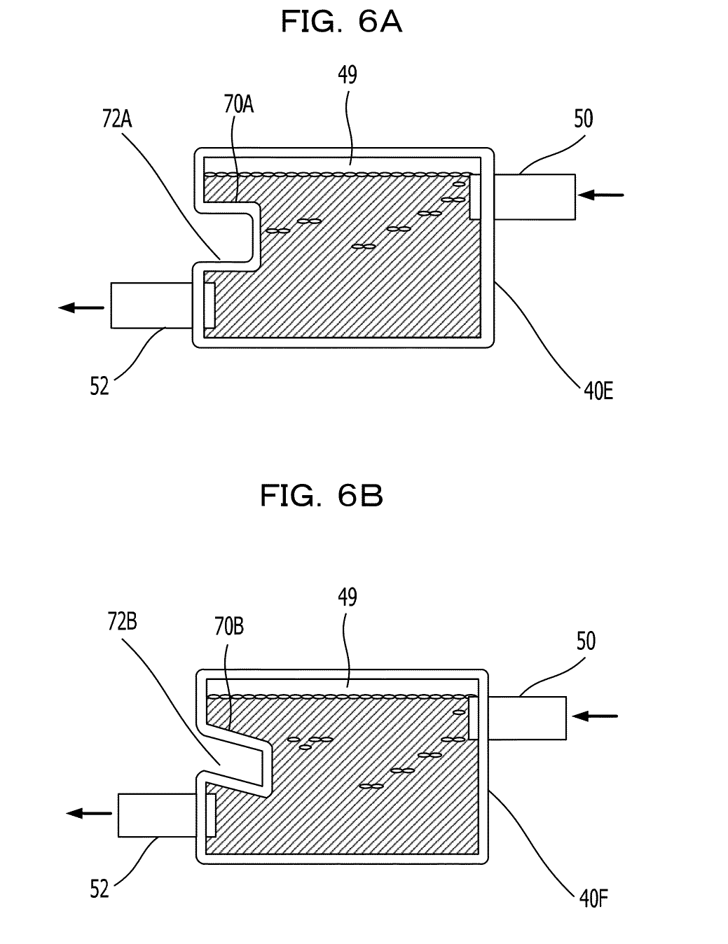

Next, with reference to FIG. 6A, the function of the protrusion 70A will be described.

With reference to FIG. 6A, the air bubbles generated in the radiating circulation loop move with the flow of coolant and flow through the inlet 50 into the tank 40E. Since the air bubbles have a lower specific gravity than coolant, the air bubbles accumulate in a region in the upper part of the inside of the tank 40E, and form an air layer 49.

In order not to send the air forming the air layer 49 to the pump 80, the outlet 52 is provided in the lower part of the tank 40E. Even if air bubbles flowing into the tank 40E through the inlet 50 together with coolant sink into coolant, air bubbles near the outlet 52 may be kept from being sucked into the outlet 52, by the protrusion 70A provided above the outlet 52.

Thus, according to this embodiment, an air lock of the pump 80 may be suppressed.

Next, with reference to FIG. 6B, a tank 40F of a sixth embodiment will be described. FIG. 6B is a sectional view of the tank 40F. Unlike the protrusion 70A of the tank 40E according to the fifth embodiment, the protrusion 70B of the tank 40F of this embodiment is inclined downward toward the bottom of the tank 40F. Since the protrusion 70B is inclined downward, air bubbles may be kept from being sucked into the outlet 52 even if air bubbles flowing into the tank 40F through the inlet 50 together with coolant sink deeply into coolant.

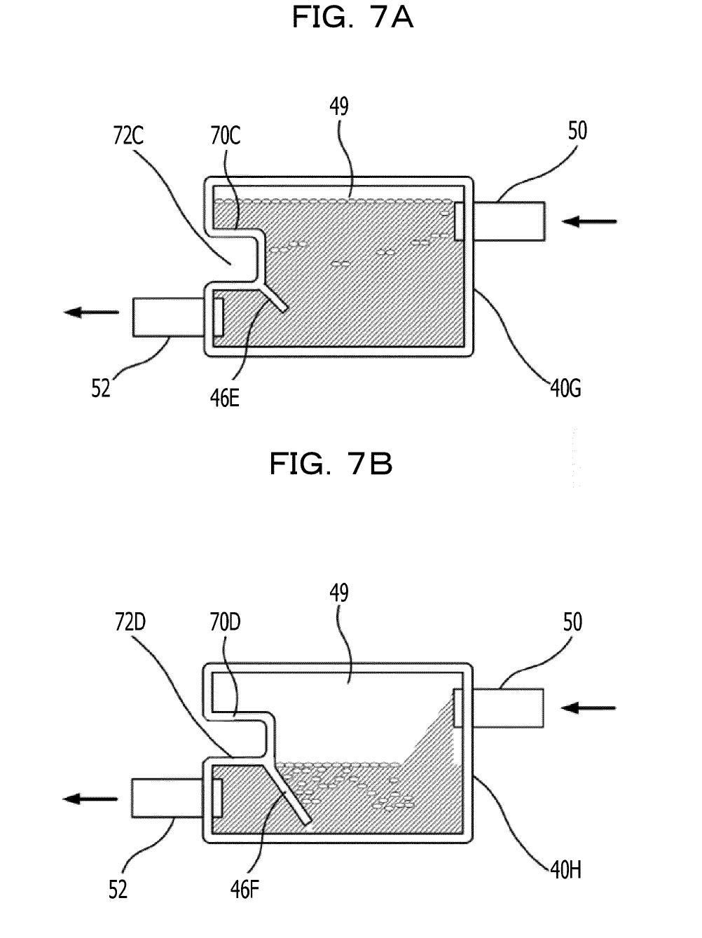

Next, with reference to FIG. 7A, a tank 40G of a seventh embodiment will be described. FIG. 7A is a sectional view of the tank 40G. Unlike the protrusion 70A of the tank 40E according to the fifth embodiment, the protrusion 70C of the tank 40G of this embodiment has a downwardly inclined plate-like overhanging portion 46E at the distal end thereof. Since the overhanging portion 46E at the distal end of the protrusion 70C is inclined downward, air bubbles may be kept from being sucked into the outlet 52 even if air bubbles flowing into the tank 40G through the inlet 50 together with coolant sink more deeply into coolant.

Next, with reference to FIG. 7B, a tank 40H of an eighth embodiment will be described. FIG. 7B is a sectional view of the tank 40H. The plate-like overhanging portion 46F provided at the distal end of the protrusion 70D of this embodiment is longer than the plate-like overhanging portion 46E at the distal end of the protrusion 70C according to the seventh embodiment, and the flow path to the outlet 52 is narrowed. Since the overhanging portion 46F at the distal end of the protrusion 70D is significantly inclined downward, air bubbles may be kept from being sucked into the outlet 52 even if air bubbles flowing into the tank 40H through the inlet 50 together with coolant sink more deeply into coolant.

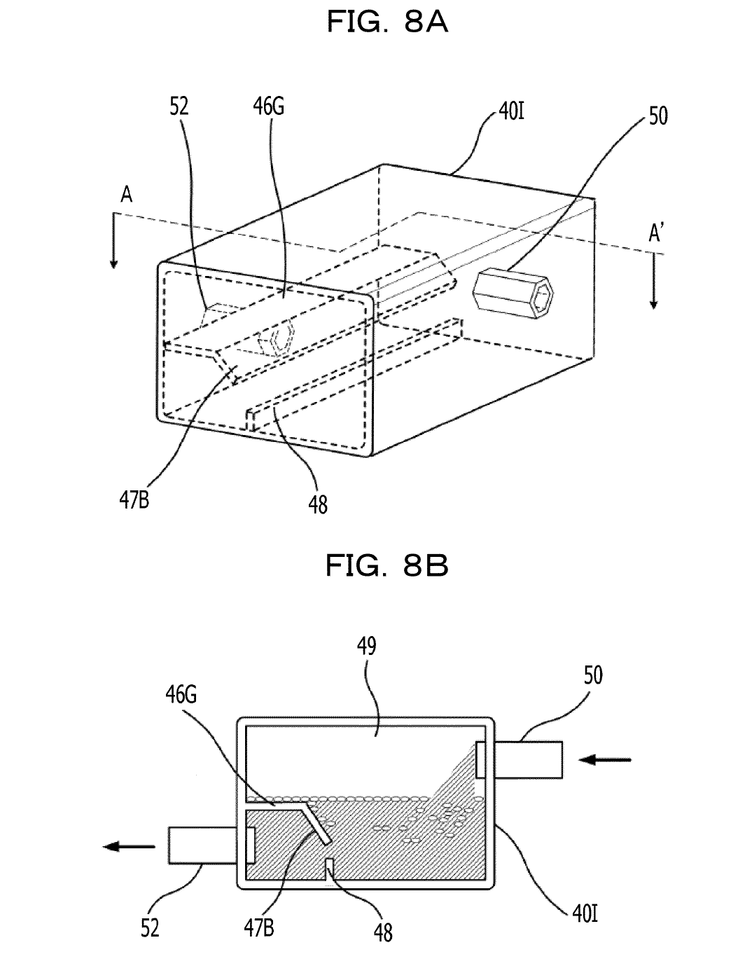

Next, with reference to FIG. 8, a tank 40I of a ninth embodiment will be described. FIG. 8A is a transparent perspective view of the tank 40I. FIG. 8B is a vertical sectional view of the tank 40I in FIG. 8A taken along line VIIIB-VIIIB and in the direction of the arrows. As with the plate-like overhanging portion 46C according to the third embodiment, which is illustrated in FIG. 3C, the distal end 47B of the plate-like overhanging portion 46G of the tank 40I of this embodiment is inclined downward. In this embodiment, a plate-like protrusion 48 is protruded from the bottom of the tank 40I toward the distal end 47B of the plate-like overhanging portion 46G in a vertical direction. Since the coolant flow path to the outlet 52 is narrowed by the plate-like protrusion 48 and the plate-like overhanging portion 46G, air bubbles are kept from being sucked into the pump 80 even if air bubbles flow forcefully into the tank 40I together with coolant.

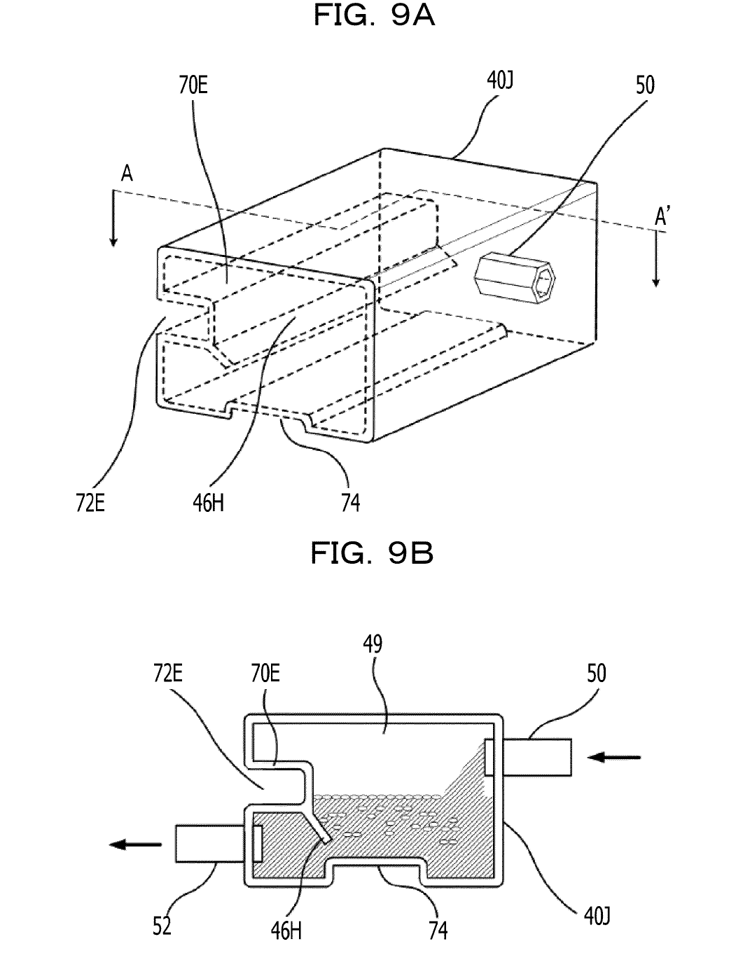

Next, with reference to FIG. 9, a tank 40J of a tenth embodiment will be described. FIG. 9A is a transparent perspective view of the tank 40J. FIG. 9B is a vertical sectional view of the tank 40J in FIG. 9A taken along line IXB-IXB and in the direction of the arrows. The protrusion 70E of the tank 40J of this embodiment and the overhanging portion 46H at the distal end thereof have the same shape as the protrusion 70C according to the seventh embodiment illustrated in FIG. 7A and the overhanging portion 46E at the distal end thereof. In this embodiment, a second protrusion 74 is protruded from the bottom of the tank 40J toward the inside of the tank 40J. Since the coolant flow path to the outlet 52 is narrowed by the second protrusion 74 and the plate-like overhanging portion 46H at the distal end of the protrusion 70E, air bubbles are kept from being sucked into the pump 80 even if air bubbles flow forcefully into the tank 40J together with coolant.

In any of the embodiments, an air lock of the pump 80 may be suppressed. Since air bubbles generated in the radiating circulation loop finally accumulate in the tank 40, the amount of coolant flowing through the radiating circulation loop is substantially stable, and a decrease in cooling efficiency may be suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A cooling unit comprising:
a flow path that circulates coolant; and
a tank that stores the coolant, the tank including
a plurality of side walls,
an inlet that is provided in a first side wall of the plurality of side walls and through which the coolant is caused to flow in,
an outlet that is provided in a second side wall other than the first side wall and located below the inlet and through which the coolant is discharged, and
an overhanging portion provided on the inner wall surface of the second side wall and located above the outlet.

2. The cooling unit according to claim 1, wherein the overhanging portion is a flat plate protruding from the inner wall surface of the second side wall in a horizontal direction, and the distal end of the overhanging portion is located below the inlet.

3. The cooling unit according to claim 1, wherein the overhanging portion is a flat plate that protrudes obliquely downward from the second side wall and the distal end of the overhanging portion is located below the inlet.

4. A cooling unit comprising:
a flow path that circulates coolant; and
a tank that stores the coolant, the tank including
a plurality of side walls,
an inlet that is provided in a first side wall of the plurality of side walls and through which the coolant is caused to flow in,
an outlet that is provided in a second side wall other than the first side wall and located below the inlet and through which the coolant is discharged, and
a protrusion that is provided in a part of the second side wall above the outlet and that protrudes into the tank.

5. The cooling unit according to claim 4, wherein the protrusion has a shape such that the outer wall of the tank is depressed and protruded toward the inside.

6. The cooling unit according to claim 5, wherein a plate-like overhanging portion is formed at the distal end of the protrusion.

7. The cooling unit according to claim 6, wherein the distal end of the plate-like overhanging portion is located below the inlet.

8. The cooling unit according to claim 1, wherein a radiating fin that cools the coolant, and a cooling sheet that absorbs heat from a heat-generating component with the coolant are connected to the flow path.

9. The cooling unit according to claim 8, wherein a pump that produces a flow of coolant is connected to the flow path, and the tank is provided between the pump and the flow path.
